(19) United States
(12) Patent Application Publication
(10) Pub. No.: US 2007/0067782 A1
(43) Pub. Date: Mar. 22, 2007

(54) Slim-type recording and reproducing apparatus having positioning structure for positioning a tray therein

(75) Inventor: Min-Cheng Yang, Hsinchu City (TW)

Correspondence Address: BIRCH STEWART KOLASCH & BIRCH, PO BOX 747, FALLS CHURCH, VA, 22040-0747, US

(73) Assignee: Lite-On It Corporation, Taipei City (TW)

(21) Appl. No.: 11/336,995

(22) Filed: Jan. 23, 2006

(30) Foreign Application Priority Data
Sep. 16, 2005 (TW) 094132146

(51) Int. Cl. G11B 17/04; G11B 33/02; G11B 17/03

(52) U.S. Cl. 720/610

(57) ABSTRACT

A recording reproducing apparatus includes a tray disposed within an outer casing and movable along a tray moving direction between retracted and extended positions. A positioning structure includes a locking member disposed below the tray, and having a base portion fixed on the outer casing, a distal portion and a constricted middle portion that extends into a guiding groove in the tray and that has a cross section smaller than that of the distal portion; and a fastening member fixed to the tray, and having a hooking part for hooking the constricted middle portion of the locking member at the retracted position

### FIELD OF THE INVENTION

The present invention relates to a positioning structure, more particularly to a positioning structure for use in a slim-type recording and reproducing apparatus. The positioning structure is used for positioning the disk-carrying tray stationarily within the recording and reproducing apparatus.

### BACKGROUND OF THE INVENTION

A conventional recording and reproducing apparatus of slim-type is generally installed within a portable computer, such as a notebook computer. Thus, production of recording and reproducing apparatus plays a major role in the computer industry.

The main object of the manufacturer is to find a way to reduce the volume or size of the recording and reproducing apparatus during the development thereof so as to facilitate in the carrying along or storage.

FIG. 1 shows a bottom side view of a conventional recording and reproducing apparatus 10 of slim-type, and includes an outer casing 5, and a disk-carrying tray 12 mounted within the outer casing 5. The tray 12 is movable with respect to the outer casing 5 between a retracted position, in which the tray 12 is retracted into the outer casing 5 to read a disk placed on the tray 12, and an extended position, in which the tray 12 is protruded outwardly from the outer casing 5.

The tray 12 is formed with a guiding groove 13. A locking device 2 is used in the conventional recording and reproducing apparatus 10 in order to position the tray 12 stationarily at the retracted position. The locking device 2 includes a locking member 204, a fastening member 202, and a tray ejection mechanism (not shown). The fastening member 202 is disposed on the tray 12 adjacent to a front end of the tray 12 and has a hooking part for. engaging the locking member 204.

Referring to FIG. 2, a pin serves as the locking member 204, and includes a head fixed with a hole in the bottom part of the outer casing 5 and a pillar portion extending into the guiding groove 13 so as to permit sliding over and engaging the hooking part of the fastening member 202 when the tray 12 is disposed at the retracted position. Under this condition, the tray 12 is prevented from moving to the extended position. In the event, the tray 12 is required to be ejected, the fastening member 202 is activated to remove the hooking part form the pin 204 resulting in disengagement between the pillar portion of the pin 204 and the hooking part of the fastening member 202, thereby permitting the tray 12 to move from the retracted position to the extended position.

Some disadvantages resulting from the use of the conventional recording and reproducing apparatus are as follows:
The outer casing 5 is subjected to receive shock (vibration) due to many reasons, such as during transport or in operation. The vibration direction may tend in the tray moving direction or transverse to the tray moving direction. When the pillar portion of the pin 204 is impacted frequently at the distal end, the shank portion may eventually bend with respect to the bottom part of the outer casing 5 since the torque applied thereat is the greatest (F=m×d, wherein d denotes the length of the pillar portion measured from the bottom part of the outer casing 5). Bending of the pillar portion may result in poor engagement between the fastening member 202 and the locking member 204 when the tray 12 is disposed at the retracted position. Moreover, in case, the outer casing 5 receives the shock in the transverse direction, the hooking part of the fastening member 202 tends to disengage from the locking member 202 since the distal end of the latter is not provided with any restricting means.

### SUMMARY OF THE INVENTION

The object of the present invention is to provide a slim-type optical recording and reproducing apparatus having positioning structure to overcome the aforesaid disadvantages encountered during use of the conventional recording and reproducing apparatus.

According to the present invention, an optical recording and reproducing apparatus is provided to include: an outer casing having a tray-receiving compartment and an entrance for access into the compartment, the outer casing further defining a tray moving direction; a tray disposed within the outer casing and movable along the tray moving direction between a retracted position, in which the tray is retracted into the outer casing, and an extended position, in which the tray is protruded outwardly from the outer casing via the entrance, the tray having a guiding groove; and a positioning structure. The positioning structure includes: a locking member disposed below the tray, and having a base portion fixed on the outer casing, a distal portion and a constricted middle portion that extends into the guiding groove in the tray and that has a cross section smaller than that of the distal portion; and a fastening member fixed to the tray, and having a hooking part for hooking the constricted middle portion of the locking member at the retracted position in order to position the tray stationarily with respect to the outer casing.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a bottom side view of a conventional optical recording and reproducing apparatus of slim-type;

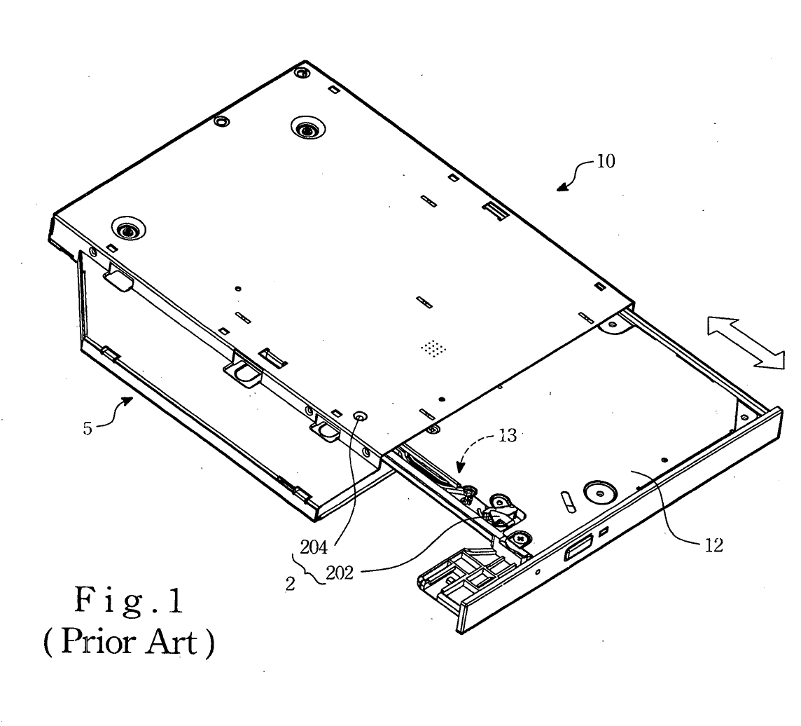

FIG. 2 is a sectional side view illustrating a positioning structure of the conventional optical recording and reproducing apparatus;

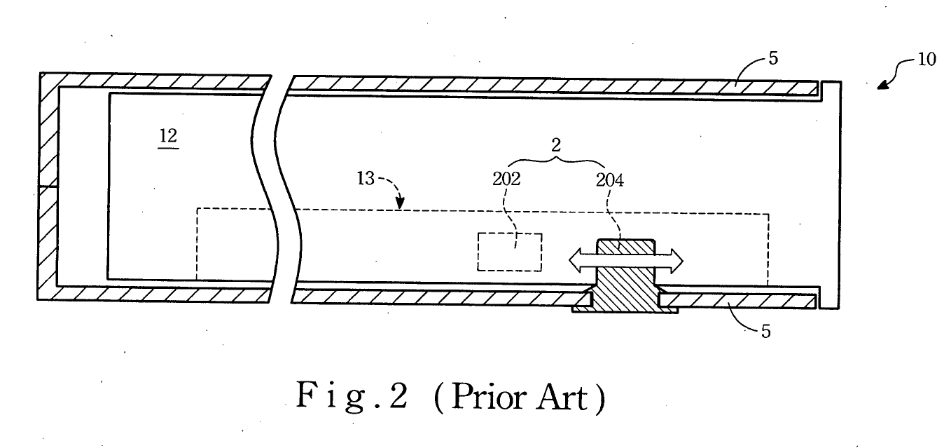

FIG. 3 is a sectional side view illustrating a first embodiment of a positioning structure of the optical recording and reproducing apparatus of the present invention;

FIG. 4 is a partly exploded and enlarged view illustrating a second embodiment of the positioning structure in the optical recording and reproducing apparatus of the present invention;

FIG. 5 is a partly exploded and enlarged view illustrating a third embodiment of the positioning structure in the optical recording and reproducing apparatus of the present invention; and

FIG. 6 is a partly exploded and enlarged view illustrating a fourth embodiment of the positioning structure in the optical recording and reproducing apparatus of the present invention.

### DETAILED DESCRIPTION OF THE PREFERRED EMBODIMENTS

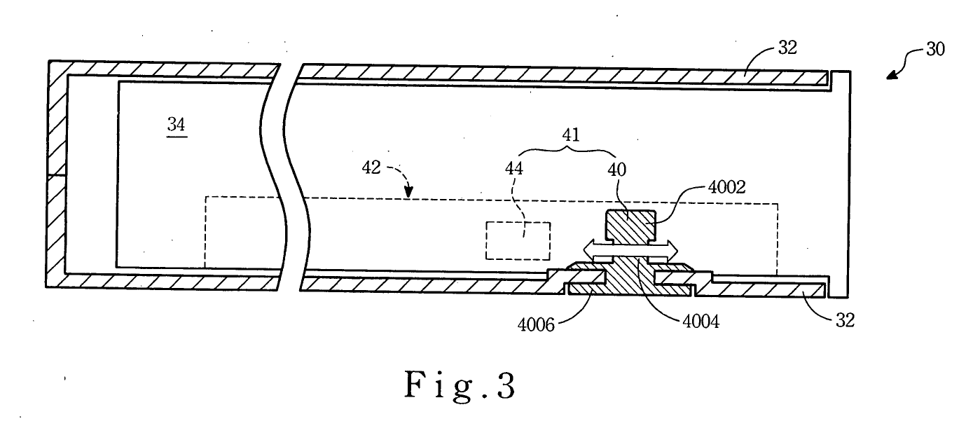

FIG. 3 is a sectional side view of the slim-type optical recording and reproducing apparatus 30 of the present invention. The apparatus 30 accordingly includes an outer casing 32 formed by upper and lower halves and a disk tray 34. The outer casing 32 defines a tray-receiving compartment and an entrance for access into the compartment. The outer casing 32 further defines a tray moving direction. The disk tray 34 is disposed within the compartment and is movable along the tray moving direction between a retracted position, in which the disk tray 34 is retracted into the outer casing 32, and an extended position, in which the tray 34 is protruded outwardly from the outer casing 32 via the entrance. Some electronic components, such as a spindle motor for rotating the disk, a heading head for reading the disk during rotation, are disposed on the disk tray 34. The disk tray 34 is formed with a guiding groove 42 along one peripheral side thereof. Since the structure of these components is not relevant to the present invention, a detailed description thereof is omitted herein for brevity sake.

A positioning structure 41 is employed in the optical recording and reproducing apparatus of the present invention. The positioning structure 41 includes a locking member 40 and a fastening member 44. The locking member 40 is disposed below the tray 34, and has a base portion 4006 fixed on the lower half of the outer casing 32, a distal portion 4002 and a constricted middle portion 4004 that extends into the guiding groove 42 in the tray 34 and that has a cross section smaller than that of the distal portion 4002. In this embodiment, a pin serves as the locking member 44 and can be integrally formed with the lower half of the outer casing 32.

The fastening member 44 is fixed to the tray 34, and has a hooking part for hooking the constricted middle portion 4004 of the locking member 40 when the tray 34 is disposed at the retracted position in order to position the tray 34 stationarily with respect to the outer casing 32. Under this condition, when the outer casing 32 receives a shock in the direction transverse to the tray moving direction, the hooking part of the fastening member 44 will not slipped off the locking member 40 by virtue of limitation of the distal portion 4002, thereby enhancing the performance of the positioning structure to lock the tray 34 at the retracted position. Under this condition, reading operation of the disk can be conducted when the disk is present on the disk tray 34.

When it is required to remove the disk tray 34 from the outer casing 32, the fastening member 44 is activated to result in disengagement between the constricted middle portion 4004 of the pin 40 and the hooking part of the fastening member 44, thereby permitting the tray 34 to move from the retracted position to the extended position.

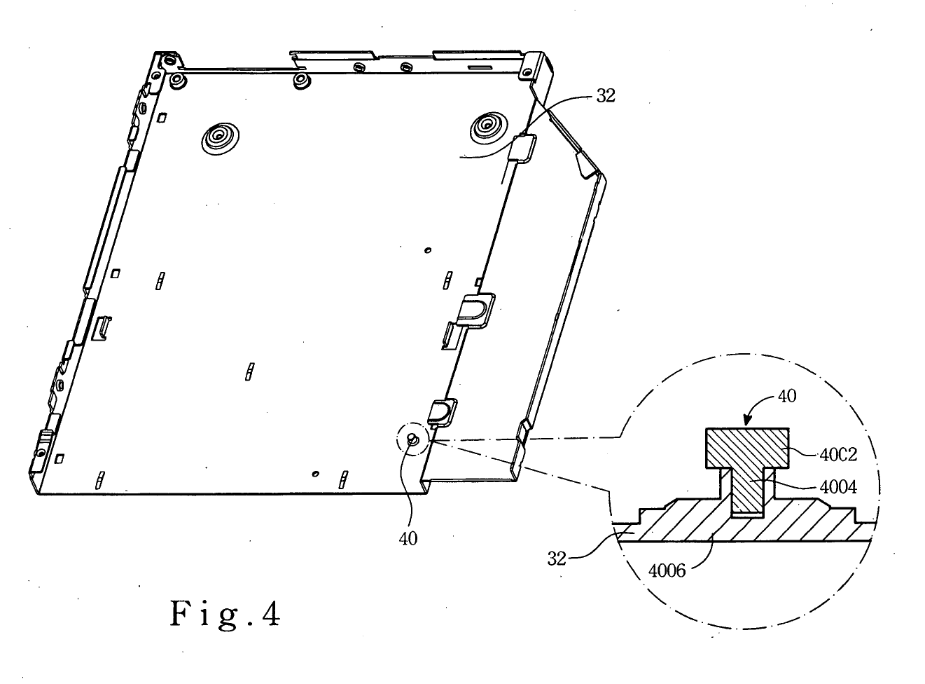

FIG. 4 shows a second embodiment of the recording and reproducing apparatus of the present invention, and has the structure similar to the previous embodiment. The main difference resides in that the base portion 4006 is integrally formed with the lower half of the outer casing 32. The constructed middle portion 4004 is press-fitted into the base portion 4006 in such a manner to expose the distal portion 4002 above the base portion 4006 such that when the tray 34 is disposed at the retracted position, the hooking part of the fastening member 44 (not shown in this drawing) hooks a section of the base portion 4006 below the distal portion 4002 in order to position the tray 34 stationarily with respect to the outer casing 32.

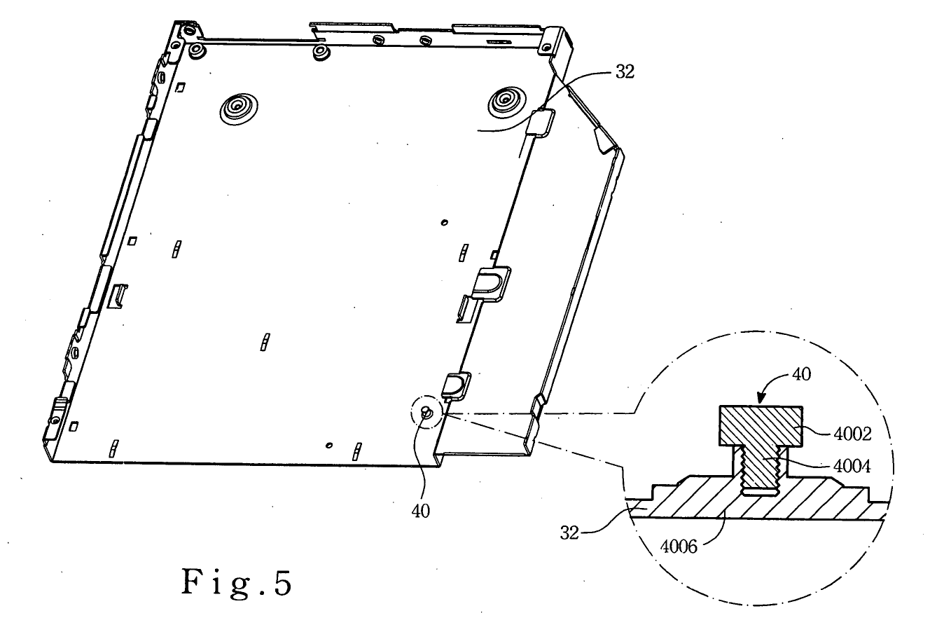

FIG. 5 shows a third embodiment of the recording and reproducing apparatus of the present invention, and has the structure similar to the second embodiment. The only difference resides in that the base portion 4006 is integrally formed with the lower half of the outer casing 32. The constructed middle portion 4004 is inserted threadedly into the base portion 4006 in such a manner to expose the distal portion 4002 above the base portion 4006 such that when the tray 34 is disposed at the retracted position, the hooking part of the fastening member 44 (not shown) hooks a section of the base portion 4006 below the distal portion 4002 in order to position the tray 34 stationarily with respect to the outer casing 32.

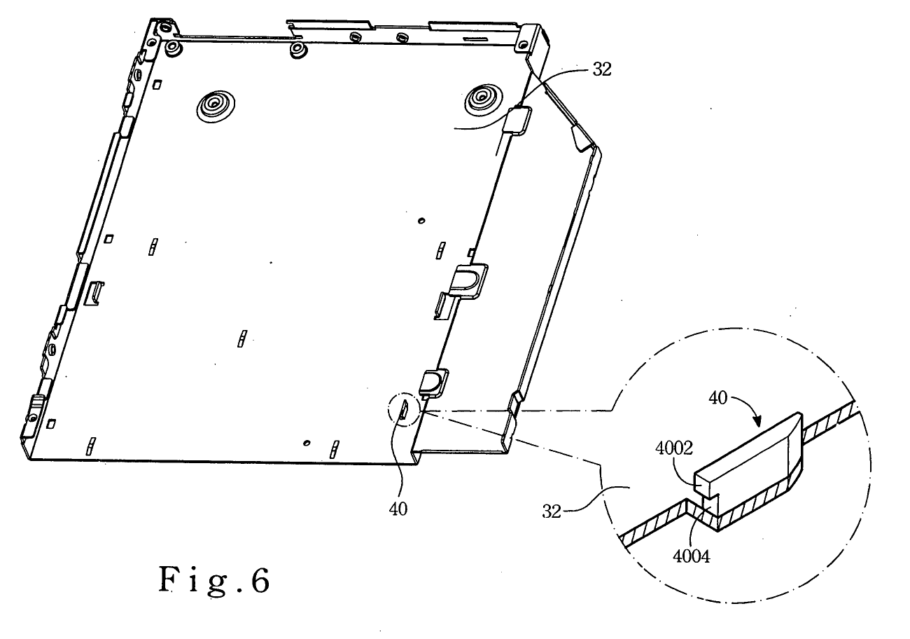

FIG. 6 shows a fourth embodiment of the recording and reproducing apparatus of the present invention, and has the structure similar to the first embodiment. The cross section of the constricted middle portion 4004 of the locking member 40 is smaller than that of the distal portion 4002. The only difference resides in that the constricted middle portion 4004 of the locking member 40 has a shape of rectangle. The distal portion 4002 has a lower side face extending in a direction parallel to the tray moving direction. The constricted middle portion 4004 has a lateral peripheral wall extending perpendicularly to the tray moving direction so as to define a right angle therebetween. The hooking part of the fastening member 44 is prevented from upward movement due to formation of the right angle between the distal portion 4002 and the constricted middle portion 4004.

Summarizing the abovementioned paragraphs, the hooking part of the fastening member 44 is prevented from being slipped of the locking member 40 due to the enlarged distal portion 4002 when the outer casing 32 receives the shock. In addition, the hooking part of the fastening member 44 has an inclined face to collide against the locking member 40, the impact is greatly reduced and little damage is done onto the locking member 40. The service life of the present recording and reproducing apparatus is consequently prolonged.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An optical recording and reproducing apparatus comprising:
an outer casing having a tray-receiving compartment and an entrance for access into said compartment, said outer casing further defining a tray moving direction;
a tray disposed within said outer casing and movable along said tray moving direction between a retracted position, in which said tray is retracted into said outer casing, and an extended position, in which said tray is protruded outwardly from said outer casing via said entrance, said tray having a guiding groove; and
a positioning structure including:
a locking member disposed below said tray, and having a base portion fixed on said outer casing, a distal portion and a constricted middle portion that extends into said guiding groove in said tray and that has a cross section smaller than that of said distal portion; and
a fastening member fixed to said tray, and having a hooking part for hooking said constricted middle portion of said locking member at said retracted position in order to position said tray stationarily with respect to said outer casing.

2. The optical recording and reproducing apparatus according to claim 1, wherein the recording and reproducing apparatus is a slim-type.

3. The optical recording and reproducing apparatus according to claim 1, wherein said locking member is a pin.

4. The optical recording and reproducing apparatus according to claim 3, wherein said pin is integrally formed with said outer casing.

5. The optical recording and reproducing apparatus according to claim 1, wherein said outer casing includes a lower half casing and an upper half casing, said base portion being integrally formed with said lower half casing, said constructed middle portion being press-fitted into said base portion.

6. The optical recording and reproducing apparatus according to claim 1, wherein said outer casing includes a lower half casing and an upper half casing, said base portion being integrally formed with said lower half casing, said constructed middle portion being inserted threadedly into said base portion.

7. The optical recording reproducing apparatus according to claim 1, wherein said distal portion has a lower side face extending in a direction parallel to said tray moving direction, said constricted middle portion having an peripheral wall extending perpendicularly to said tray moving direction so as to define a right angle therebetween.
